(19) United States
(12) Patent Application Publication
(10) Pub. No.: US 2015/0169286 A1
(43) Pub. Date: Jun. 18, 2015

(54) AUDIO ACTIVATED AND/OR AUDIO ACTIVATION OF A MODE AND/OR A TOOL OF AN EXECUTING SOFTWARE APPLICATION

(71) Applicant: KONINKLIJKE PHILIPS N.V., EINDHOVEN (NL)

(72) Inventor: Shimon Ezra, Petach Tekva (IL)

(21) Appl. No.: 14/417,577

(22) PCT Filed: Aug. 6, 2013
(86) PCT No.: PCT/IB2013/056435

§ 371 Date: Jan. 27, 2015

Related U.S. Application Data
(60) Provisional application No. 61/679,926, filed on Aug. 6, 2012.

(51) Int. Cl. G06F 3/16

(52) U.S. Cl. CPC G06F 3/167

(57) ABSTRACT

A method includes receiving audio at a computing apparatus (104), determining, by the computing apparatus, whether the audio corresponds to a predetermined mapping between an utterance and a software call of software application executing on the computing apparatus, and invoking the software call only in response to the audio corresponding to the software call, wherein the invoked software call at least one of activates or deactivates at least one of a mode or a tool of the executing software application.

The following generally relates to modes and/or tools of an executing software application visually presented in a user interactive graphical user interface (GUI) and more particularly to activating (and deactivating) a mode and/or tool through an audio command.

Imaging data in electronic format has been visually presented in a user interactive GUI of executing application software displayed through a monitor. Application software that allows for manipulating the imaging data, such as segmenting the imaging data, has included mode selection and tool activation controls displayed on a menu, palette or the like and accessible through drop/pull down menus, tabs and the like. Unfortunately, many of these controls may be nested deep in menus and/or generally hidden such that the user has to navigate through a menu structure using several mouse clicks to find and activate a desired mode and/or tool. That is, the soft control for activating a mode or tool may not be visually presented in an intuitive way such that a desired mode or tool can be easily found and activated using the mouse.

Attempts to present such controls in an intuitive manner are discussed next. In one instance, context sensitive filters have been used on existing tool palettes such that only tools deemed more relevant are displayed on the toolbar for the user. Some tool palettes allow the user to add and/or remove tools from the palette, while keeping other less used tools hidden so as not to clutter palette. Other tool palettes learn as tools are used and either add and/or remove tools automatically. Other tool palettes are floatable in that a user can click on, drag, and place the tool palette at a desired location within the viewport. However, all of these attempts still require the user to exit from the current mode of operation and/or tool and search for the mode/tool that of interest to enter/activate via the mouse and/or keyboard.

Unfortunately, the above noted and/or other actions of exiting a current mode of operation and/or tool to search for the mode/tool using the mouse and/or keyboard may distract the user from a current mode of thinking and might take an inordinate amount of time to find the mode/tool of interest. Thus, there is an unresolved need for other approaches to finding and/or activating/deactivating a mode/tool of interest in an interactive GUI of an executing software application.

Aspects described herein address the above-referenced problems and others.

In one aspect, a method includes receiving audio at a computing apparatus, determining, by the computing apparatus, whether the audio corresponds to a predetermined mapping between an utterance and a software call of software application executing on the computing apparatus, and invoking the software call only in response to the audio corresponding to the software call, wherein the invoked software call at least one of activates or deactivates at least one of a mode or a tool of the executing software application

In another aspect, a computing apparatus includes an audio detector that detects audio, memory that stores, at least, application software, and a main processor that executes the application software. The executing application software determines whether the detected audio corresponds to a predetermined mapping between an utterance and a software call of software application executing on the computing apparatus and invokes the software call only in response to the audio corresponding to the software call.

In another aspect, a computer readable storage medium encoded with one or more computer executable instructions, which, when executed by a processor of a computing system, causes the processor to: receive audio, determine whether the audio corresponds to a predetermined mapping between an utterance and a software call of software application executing on the computing apparatus, and invoke the software call only in response to the audio corresponding to the software call, wherein the invoked software call at least one of activates or deactivates at least one of a mode or a tool of the executing software application.

The invention may take form in various components and arrangements of components, and in various steps and arrangements of steps. The drawings are only for purposes of illustrating the preferred embodiments and are not to be construed as limiting the invention.

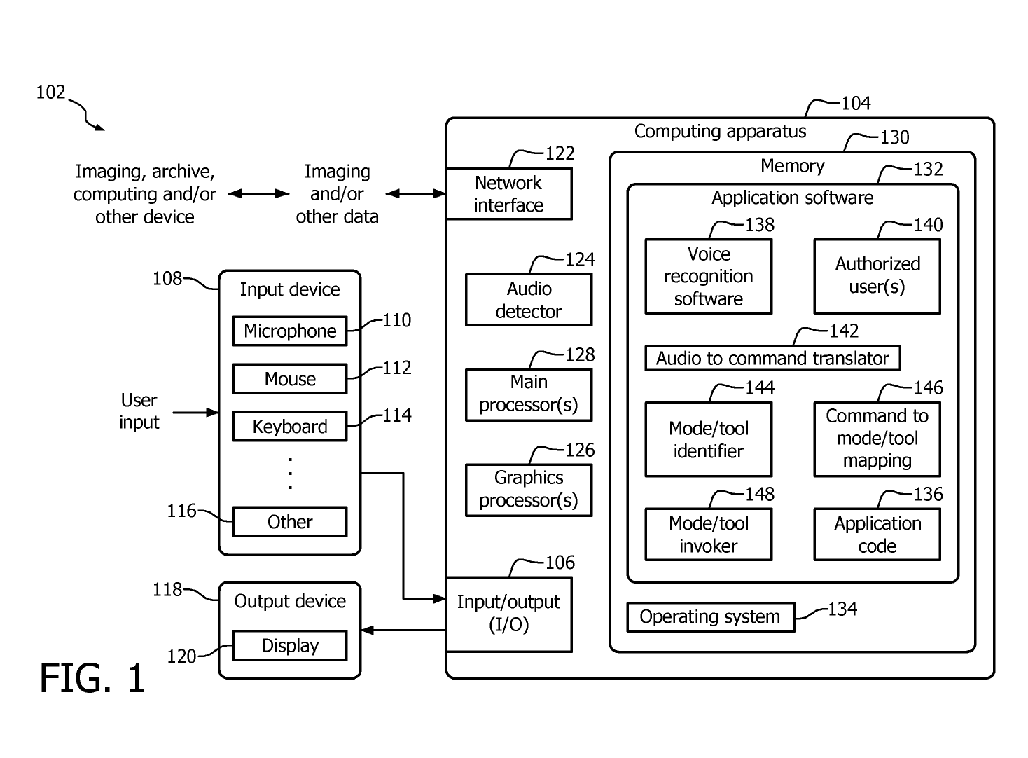

FIG. 1 schematically illustrates a computing system with application software that includes an audio recognition feature that allows a user to select a mode and/or tool using audio commands instead of mouse and/or keyboard commands.

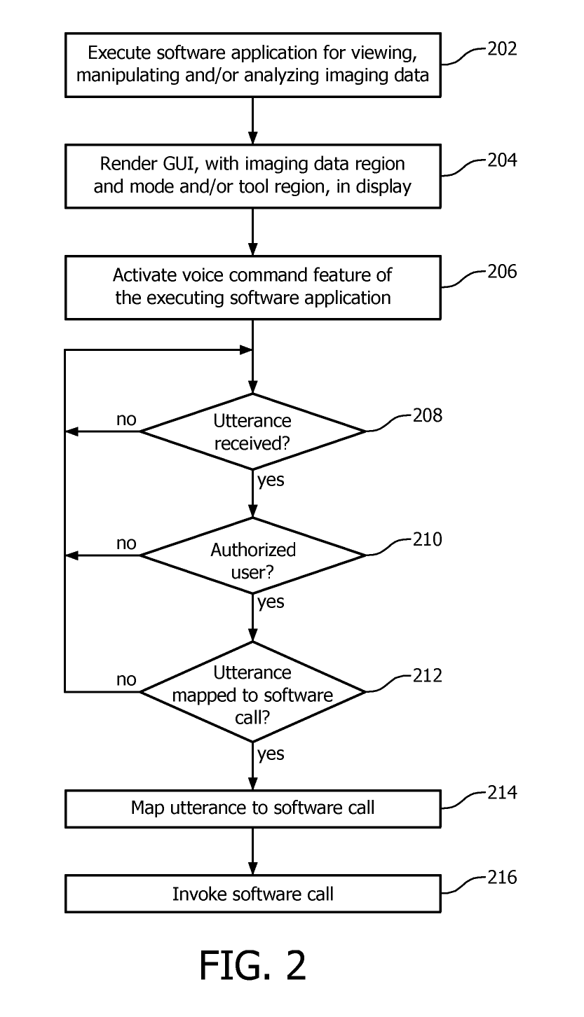

FIG. 2 illustrates an example method that allows a user to select a mode and/or tool via audio commands instead of mouse and/or keyboard commands.

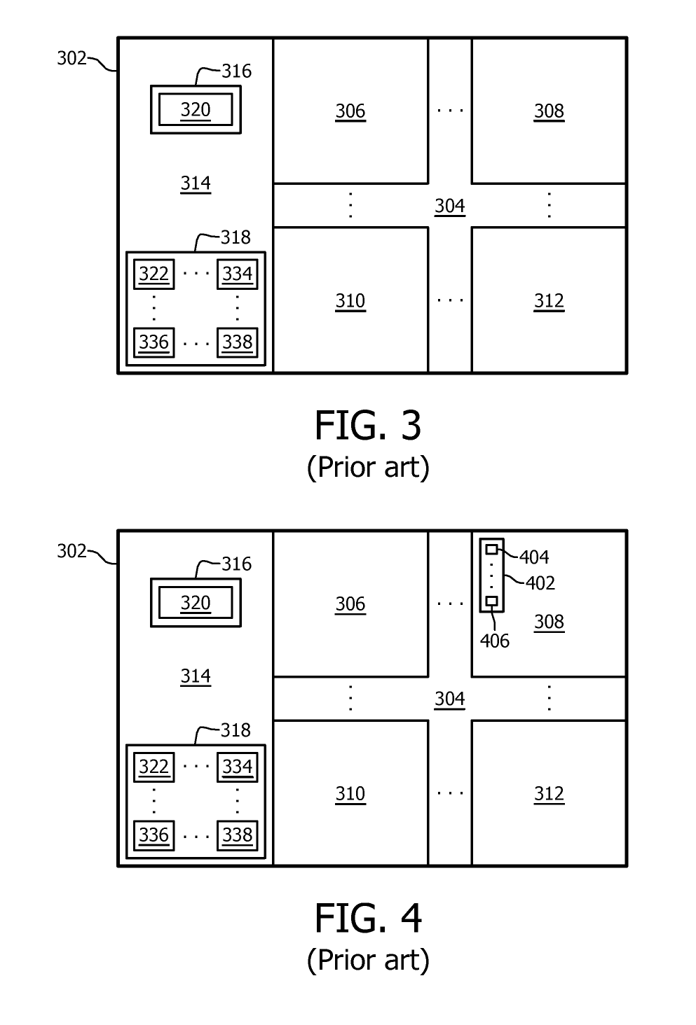

FIG. 3 depicts a prior art graphical user interface in which a mouse is used to activate a tool.

FIG. 4 depicts the prior art graphical user interface of FIG. 3 in which the mouse is used to activate a sub-tool presented in a floating menu.

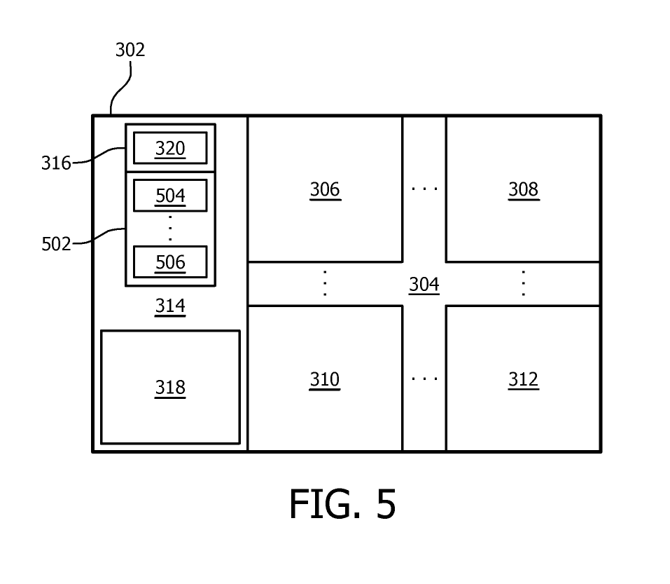

FIG. 5 depicts the prior art graphical user interface of FIG. 3 in which the mouse is used to switch between modes.

The following describes a system and/or method in which a predetermined subset of modes/tools of application software executing in an interactive GUI is selectable for activation and/or deactivation through audio (and/or mouse/keyboard) commands. Audio (such as voice) commands allows a user to select and activate a mode and/or tool of interest without having to exit a current mode or tool, search for the mode and/or tool of interest and manually select it via the mouse or keyboard, break their concentration and/or observation of the visually presented imaging data, etc. The mouse and/or keyboard are then employed to use the mode and/or tool. Each mode and/or tool is assigned a word and/or words that activate and/or deactivate it (where a word and/or words can be general to many users and/or specific to an individual user), and when the application software identifies an assigned word(s), it activates and/or deactivates the mode and/or tool. This feature can be activated and/or deactivated on-demand by a user and/or otherwise.

FIG. 1 schematically illustrates a computing system 102. The computing system 102 includes a computing apparatus 104 such as a general purpose computer, a workstation, a laptop, a tablet computer, an imaging system console, and/or other computing apparatus 104. The computing apparatus 104 includes input/output (I/O) 106, which is configure to electrically communicate with one or more input devices 108 (e.g., a microphone 110, a mouse 112, a keyboard 114, . . . , and/or other input device 116) and one or more output devices 118 (e.g., a display 120, a filmer, and/or other output device).

A network interface 122 is configured to electronically communicate with one or more imaging, data storage, computing and/or other devices. In the illustrated embodiment, the computing apparatus 104 obtains at least imaging data via the network interface 122. The imaging and/or other data can also be store on the hard drive and/or other storage of the apparatus 104. The imaging data can be generated by one or more of a computed tomography (CT), magnetic resonance (MR), positron emission tomography (PET), single photon emission tomography (SPECT), ultrasound (US), X-ray, combination thereof, and/or other imaging device, and the data storage can be a picture archiving and communication system (PACS), a radiology information system (RIS), a hospital information system (HIS), in memory of the computer apparatus, and/or other storage.

An audio detector 124 is configured to sense an audio input and generates an electrical signal indicative thereof. For example, where the audio input is a user's voice, the audio detector 124 senses the voice and generates an electrical signal indicative of the voice input. A graphic processor(s) 126 is configured to convey a video signal, via the I/O 106, to the display 120 to visually present an image. In the illustrated embodiment, in one instance, the video signal renders an interactive graphical user interface (GUI) with one or more display regions or viewports for rendering images such as image data, one or more regions with soft controls for invoking one or more modes and/or one or more tools for manipulating, analyzing, filming, storing, etc. a rendered image.

A main processor 128 (e.g., a micro-processor, controller, or the like) controls the I/O 106, the network interface 122, the audio detector 124, the graphics processor(s) 126 and/or one or more other components of the computing apparatus 104. The main processor 128 can include one or more processors that execute one or more computer readable instructions encoded, embedded, stored, etc. on computer readable storage medium such as physical memory 130 and/or other non-transitory memory. In the illustrated embodiment, the memory 130 includes at least application software 132 and an operating system 134. The main processor 128 can also execute computer readable instructions carried by a signal, carrier wave and/or other transitory medium.

In another embodiment, one or more of the above components can be part of or can also be part of on an external machine, for example, in client server mode part of the graphics processor and/or part of the computing components that are on the server, with the rest of the components on the client.

In the illustrated embodiment, the application software 132 includes application code 136, for example, for an imaging data viewing, manipulating and/or analyzing application, which includes various modes (e.g., view series, segment, film, etc.) and tools (e.g., zoom, pan, draw, etc.). The application software 132 further includes voice recognition software 138, which compares the detection signal from the audio detector 124 with signals for one or more predetermined authorized user(s) 140 using known and/or other voice recognition algorithms, and generates a recognition signal that indicates whether the audio is from a user authorized to use the application software 132 and, if so, optionally, an identification of the authorized user.

In a variation, the components 138 and 140 are omitted. In such an instance, log in information may be used to identify the command to mode/tool mapping for the user. Where the components 138 and 140 are included, the computing apparatus 104 can be invoked to run training application code of the application code 136 or other application code in which different users of the system train the application software 132 to learn and/or recognize their voice and associate their voice with the corresponding command to mode/tool mapping. In this instance, the application software 132 may first determine whether a user is authorized to use the audio command feature. If not, the feature is not activated, but if so, the application software 132 will activate the feature and know which command to mode/tool mapping to use.

The illustrated application software 132 also includes an audio to command translator 142, which generates a command signal based on the detection signal. For example, the audio to command translator 142 may generate a command signal for the term “segmentation” where the audio to command translator 142 determines the detection signal corresponds to the spoken word “segmentation.” The application software 132 may repeat the term back and/or visually present the term and wait for user confirmation. It is to be appreciated that nonsensical or made up words (a word(s) not part of the native language of the user), spoken sounds and/or sound patterns, non-spoken sounds and/or sound patterns (e.g., tapping an instrument, etc.), and/or other sounds can alternatively be used.

A mode/tool identifier 144 maps the command signal to a software call that activates and/or deactivates a mode and/or tool based on a predetermined command to mode/tool mapping 146. The predetermined command to mode/tool mapping 146 may include a generic mapping of a term to a software call for all users and/or a user defined mapping of a term to a software call created by a specific user.

The command to mode/tool mapping of the mappings 146 for a particular user can be provided to the computing apparatus 104 as a file through the network interface 122 and/or the I/O 106 such as via a USB port (e.g., from portable memory), a CD drive, DVD drive, and/or other I/O input devices. Additionally or alternatively, the application software 132 allows a user to manually enter a word(s)/software call pair using the keyboard 114 and/or the microphone 110 and audio detector 124. In the latter instance, the user can speak the word and software call. The application code 136 may then repeat the utterances back and ask for confirmation. Manually and/or audible entry can also be used to change and/or delete a mapping.

During mapping creation/editing and/or while employing the application software 132 to view, manipulate and/or analyze imaging data, the mapping 146 for a user can be visually displayed so that the user can see the mapping. Presentation of the mapping may also be toggled based on an audio and/or manual command. In this manner, the user can visually bring up a visual display of the mapping on-demand, for example, where the user cannot remember an audio command, wants to confirm an audio command before uttering it, wants to change an audio command, wants to delete an audio command, and/or otherwise wants the mapping displayed.

The illustrated application software 132 further includes a mode/tool invoker 148, which invokes a mode and/or tool (to activate or deactivate the mode or tool) based on the software call. For example, where the software call corresponds to the mode “segmentation” and a different mode is currently presented in the display 120, the mode/tool invoker 148 causes the application code 136 to switch to a segmentation mode. Where the software call corresponds to the mode “segmentation” and segmentation mode is currently presented in the display 120, either no action is taken or the mode/tool invoker 148 causes the application code 136 to switch out of the segmentation mode, e.g., to the previous mode and/or a default mode. In this manner, the audio input is used to toggle between the mode and one or more other modes. A software call for a tool can be similarly handled.

From the above, the application software 132 allows a user of the apparatus 104 to activate and/or deactivate a mode and/or a tool without having to manually search for and/or manually select a mode and/or tool via a mouse and/or keyboard through a series of drop, pull down, etc. menus of the display GUI. Rather, the user, while in a particular mind set and viewing particular image data, need only to speak an “utterance” that has been mapped to the software call of interest in order to switch to and/or bring up a particular tool. This facilitates improving workflow by making is easier and less time consuming to activate a mode and/or tool of interest.

Suitable applications of the system 102 include, but are not limited to, viewing imaging data in connection with an imaging center, a primary care physician, a radiologist reading room, an operating room, etc. The system 102 is well-suited for operating rooms, interventional suits, and/or other sterile environments as functionality can activated and/or deactivated through voice instead of physical touch between the clinician and the computing system hardware.

Examples of suitable modes and/or suitable tools that can be invoked through audio include, but are not limited to, mouse mode, zoom mode, pan mode, graphic creation, segmentation tools, save tools, screen layout−compare+layouts, volume selection, dialog opening, stage switch, applications activation, viewport controls changes, film, open floating menu, image navigation, image creation tools, and/or display protocols. Audio commands can also move the mouse, for example, in a particular direction, by a predetermined or user specified increment, etc. The particular modes and/or tools can be default, user defined, facility defined, and/or otherwise defined.

FIG. 2 illustrates an example method that allows a user to select a mode and/or tool via audio commands instead of mouse and/or keyboard commands.

It is to be appreciated that the ordering of the acts is not limiting. As such, other orderings are contemplated herein. In addition, one or more acts may be omitted and/or one or more additional acts may be included.

At 202, application software for viewing, manipulating and/or analyzing imaging data is executed via a computing system.

At 204, a GUI, including imaging data display regions (or viewports) and modes and/or tool selection regions, is visually presented in a display of the computing system.

At 206, the computing system activates an audio command feature of the executing application.

In one instance, the audio command feature is activated/deactivated by a user via an input device such as a mouse or keyboard in connection with an audio command feature control displayed in connection with instantiation of the application software. In this instance, the audio command feature is part of the application software 132 and not the operating system 134. In another instance, the audio command feature is activated simply in response to executing the application software. Again, in this instance, the audio or voice command feature is part of the application software 132 and not the operating system 134.

In a variation, the audio command feature is activated in response to manual or audio activation of the audio command feature through the operating system 134 before, concurrently with and/or after executing the application software. In this instance, the full audio command feature can be activated, or the audio command feature in the application software 132 can be executed in a mode in which it will only detect a command to activate/deactivate the other features and, in response thereto, either activate or deactivate the other features.

At 208, the activated audio command feature listens for utterances.

At 210, optionally, if an utterance is detected, the utterance is utilized to determine whether the user is authorized to use the system and/or an identification of the user.

If it is determined that the user is not authorized, act 208 is repeated.

Otherwise, at 212, it is determined if the utterance is mapped to a software call for a mode and/or tool.

If it is determined that the utterance is not mapped to a software call, act 208 is repeated.

Otherwise, at 214, the utterance is mapped to a software call for a mode and/or tool.

At 216, the software call invokes activation and/or deactivation of the mode and/or tool depending on a current state of the executing application, and act 208 is repeated.

The audio command feature can be temporarily disabled, for example, so as not to infer with another voice recognition program. Alternatively, a priority can be predetermined for concurrently running audio recognition programs. In another instance, a dedicate physical and/or software toggle switch can be used to toggle the audio command feature on and off.

Optionally, the utterance may invoke a command within a particular mode and/or tool. For example, an utterance can be used to select or switch between view (e.g., axial, sagittal, coronal, oblique, etc.), select or switch renderings (e.g., MIP, mIP, curved MPR, etc.), select or switch between 2D and 3D, etc. An utterance can also be used to change the view point, the data type, the image type, etc.

As discussed herein, the above allows a user to activate and/or deactivate modes and/or tools without having to manually search for and/or manually select a mode and/or tool via a mouse and/or keyboard through a series of drop, pull down, etc. menus of the display GUI, which may facilitate improving workflow by making it easier and less time consuming to activate a mode and/or tool of interest.

The above methods may be implemented by way of computer readable instructions, encoded or embedded on computer readable storage medium, which, when executed by a computer processor(s), cause the processor(s) to carry out the described acts. Additionally or alternatively, at least one of the computer readable instructions is carried by a signal, carrier wave or other transitory medium.

FIGS. 3 and 4 and FIG. 5 respectively show prior art approaches for using tools and switching between modes. In both figures, a GUI 302 includes an imaging data presentation region 304 that includes M×N (where M and N are integers) viewports windows 306, 308, 310 and 312, and a mode/tool pane 314 with a mode selection tab 316 and a tool palette 318. In this example, there is an even number of viewports, and the viewports have a same geometry. However, an odd number and/or different size viewports are also contemplated herein. Furthermore, the particular sequences discussed next represent of a subset of possible actions, and different GUIs may arrange modes and/or tools in different locations and/or required different actions to invoke them.

In FIG. 3, a mode 320 has already been selected and J×K (where J and K are integers) corresponding tools 322, 324, 326 and 328 populate the palette 318. Generally, in order for a user to activate the tool 322, while viewing imaging data in viewport 308 for example, the user, via a mouse or the like, moves a graphical pointer to the tool 322, hovers the graphical pointer over the tool 322, and clicks one or more times on the tool 322. In doing so, the user also moves their eyes and concentration away from the imaging data in the viewport 308. The user, via a mouse or the like, then moves a graphical pointer back to the viewport 308, hovers the graphical pointer over the viewport 308, and clicks one or more times on the viewport 308. The user can then employ the function provided by the tool 322 with the imaging data in the viewport 308.

In FIG. 4, the tool selected from the tool palette 318 invokes instantiation of a floating menu 402, with L (where L in an integer) sub-tools 404, 406 in the viewport 308. With this approach, the user has the additional actions of, via the mouse or the like, moving the graphical pointer to the floating tool 402, hovering the graphical pointer over the floating tool 402 and sub-tool of interest, clicking one or more times on the floating tool 402, clicking one or more times on the sub-tool of interest, and clicking one or more times back on the viewport 308. The user can then employ the function provided by the selected sub-tool with the imaging data in the viewport 308.

Turning to FIG. 5, to change modes, the user, via the mouse or the like, moves a graphical pointer to the mode selection tab 316, hovers the graphical pointer over the mode selection tab 316, and clicks one or more times on the mode selection tab 316. This invokes instantiation of an otherwise hidden mode selection box 502, which includes X (where X is an integer) modes 504, 506. To select a mode, the user, via the mouse or the like, moves a graphical pointer to a mode, hovers the graphical pointer over the mode, and clicks one or more times on the mode. The user, via the mouse or the like, then moves the graphical pointer back to a viewing window, hovers the graphical pointer over the viewing window, and clicks one or more times on the viewing window. Corresponding tools are displayed in the tool palette 318 once a mode is selected.

With respect to FIG. 3, in connection with system 102 (FIG. 1), in one non-limiting example, a user viewing imaging data in the viewport 308 can simply utter the audio command assigned to the tool 322. The user need not also moves their eyes and break their concentration with respect to the imaging data in the viewport 308. To select another tool or change modes, again, a simply utterance of the appropriate command term is all that is needed. To back out of a tool or mode, for example, where the user changes their mind or invokes the wrong tool or mode, the user may use a “back out” command term, such as a generic “back out” command term to back out of any tool or mode, a user defined term, simply repeating the same term the invoke the tool or mode, etc. With FIG. 4, a sub-tool from the floating menu can also be selected/deselected in a similar manner, and with FIG. 5, the mode can be can be selected/deselected in a similar manner. Of course, the user can still user the mouse to make selections.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method, comprising:
visually displaying a list of utterance to software call pair mappings;
receiving audio at a computing apparatus;
determining, by the computing apparatus, whether the audio corresponds to a predetermined mapping between an utterance and a software call of software application executing on the computing apparatus, in the list of utterance to software call pair mappings; and
invoking the software call only in response to the audio corresponding to the software call, wherein the invoked software call at least one of activates or deactivates at least one of a mode or a tool of the executing software application.

2. The method of claim 1, wherein the executing software application, and not an operating system of the computing apparatus, determines whether the audio corresponds to the predetermined mapping between the utterance and the software call.

3. The method of claim 1, wherein the executing software application is an imaging data viewing, manipulation and/or analyzing application.

4. The method of claim 1, wherein the executing software application invokes rendering of one or more imaging data viewports and a mode/tool pane with modes and tools corresponding to imaging data viewing, manipulation and/or analyzing.

5. The method of claim 1, wherein invoking the software call does not change a current active viewport visually presenting imaging data.

6. The method of claim 1, wherein invoking the software call does not require a movement of an input device.

7. The method of claim 1, further comprising:
translating the received audio to a command signal;
locating the command signal in the predetermined mapping;
identifying the software call corresponding to the command signal; and
invoking the identified software call.

8. The method of claim 1, wherein at least one mapping of the predetermined mapping is general to a plurality of users specific to an individual user.

9. The method of claim 1, further comprising:
receiving electronic data from at least one of an input device or a storage device, wherein the electronic data includes at least one utterance to software call mapping, and the at least one utterance to software call mapping forms part of the predetermined mapping.

10. The method of claim 1, further comprising:
receiving audio indicative of at least one utterance to software call mapping, wherein the at least one utterance to software call mapping forms part of the predetermined mapping.

11. The method of claim 1, further comprising:
identifying a source of the utterance;
determining if the source is authorized to invoke the software call; and
invoking the software call only in response to the source being authorized to invoke the software call.

12. The method of claim 1, further comprising:
toggling invocation of software calls on and off through a software call invocation audio command, wherein toggling invocation off does not interrupt the mode or tool activated by the software call.

13. The method of claim 1, further comprising:
reversing activation of the mode or the tool in response to a corresponding audio reverse software call command.

14. (canceled)

15. A computing apparatus, comprising:
an audio detector configured to detect audio;
memory configured to store, at least, application software;
a display configured to list of utterance to software call pair mappings; and
a main processor configured to execute the application software,
wherein the executing application software is configured to determine whether the detected audio corresponds to a predetermined mapping between an utterance and a software call of software application, executing on the computing apparatus, in the list of utterance to software are call pair mappings and invoke the software call only in response to the audio corresponding to the software call.

16. The apparatus of claim 15, wherein the invoked software call at least one of activates or deactivates at least one of a mode or a tool of the executing software application.

17. The apparatus of claim 15, wherein the executing software application is an imaging data viewing, manipulation and/or analyzing application.

18. The apparatus of claim 15, wherein the executing software application invokes rendering of one or more imaging data viewports and a mode/tool pane with modes and tools corresponding to imaging data viewing, manipulation and/or analyzing.

19. The apparatus of claim 15, further comprising:
a mode/tool identifier that identifies a software call corresponding to a mode or tool identified in the audio.

20. The apparatus of claim 19, further comprising:
a command to mode/tool mapping that maps utterances to software calls, wherein the mode/tool identifier identifies the software call based on the audio and the mapping.

21. The apparatus of claim 15, wherein at least one mapping of the predetermined mapping is specific to a user of the apparatus.

22. The apparatus of claim 15, wherein at least one mapping of the predetermined mapping is general to multiple users of the apparatus.

23. The apparatus of claim 15, wherein the main processor identifies a source of the utterance, determines if the source is authorized to invoke the software call, and invokes the software call only in response to the source being authorized to invoke the software call.

24. The apparatus of claim 15, wherein the main processor toggles invocation of software calls on and off in response to receiving a software call invocation audio command, wherein toggling invocation off does not interrupt the mode or tool activated by the software call.

25. The apparatus of claim 15, wherein the main processor reverses activation of the mode or the tool in response to receiving an audio reverse software call command.

26. (canceled)

27. The apparatus of claim 15, wherein the invoked software call at least one of activates or deactivates at least one feature of a mode or a tool.

28. A computer readable storage medium encoded with one or more computer executable instructions, which, when executed by a processor of a computing system, causes the processor to:
visually display a list of utterance to software call pair mappings;
receive audio;
determine whether the audio corresponds to a predetermined mapping between an utterance and a software call of software application, executing on the computing apparatus, in the list of utterance to software call pair mappings; and
invoke the software call only in response to the audio corresponding to the software call, wherein the invoked software call at least one of activates or deactivates at least one of a mode or a tool of the executing software application.
